(19) United States
(12) Patent Application Publication
(10) Pub. No.: US 2011/0240406 A1
(43) Pub. Date: Oct. 6, 2011

(54) CLEANER BLADE LUBRICATION APPLICATOR

(75) Inventor: Michael F. Zona, Holley, NY (US)

(73) Assignee: Xerox Corporation, Norwalk, CT (US)

(21) Appl. No.: 12/754,651

(22) Filed: Apr. 6, 2010

(51) Int. Cl. F16N 7/12; B05C 1/00; B05C 11/105; F16N 7/00

(52) U.S. Cl. 184/64; 118/200; 118/268; 184/14

(57) ABSTRACT

A powered lubricant fluid-delivery applicator structure comprises a casing having a closed end, and an open end opposite the closed end. A fluid-conducting applicator is located within the open end. The fluid-conducting applicator has an internal applicator section located within the casing, and an external applicator section extending outside the open end. A fluid is within the casing, and the fluid comprises a liquid and a powdered lubricant suspended in the liquid. The external applicator section comprises a tip having a V-shaped recess corresponding to a blade to which the powdered lubricant is applied.

### BACKGROUND AND SUMMARY

Embodiments herein generally relate to fluid-delivery applicator methods and structures having a fluid within a casing (the fluid comprises a powder suspended in a liquid) and an applicator comprising a tip having a recess corresponding to a blade to which the powder is applied.

Printing and copying machines that use urethane cleaning blade technology to clean photoreceptors often use a powdered lubricant to ensure that the working edge of the blade does not get damaged when the cartridge is first used in a machine. Without this lubrication, the blade would flip or tear when the photoreceptor device is first rotated against the working edge of the cleaning blade. Additionally, the use of overcoats on the latest photoreceptor device has shown even further need for startup torque reduction due to the nature of the overcoat materials against the urethane blade edge. Lubricant materials used include Zinc Stearate, Polymethylmethacrylate (PMMA), Kynar, etc. These lubricating particles are typically in the tens of nanometer to 1 micron size range depending on the application method. Some common methods of applying the lubricant to the working edge of the blade include dipping and syringe application.

In the dipping process, the preferred powder material is suspended in a liquid solution. The liquid is volatile and is chosen to evaporate readily in normal atmospheric conditions. A tray of solution is mixed to a specific viscosity. The blades are then dipped into the solution and left to dry in open air. The powder is left on the blade edge once all the liquid evaporates. The disadvantage of this method is that the viscosity of the solution in the tray must be continuously monitored to ensure the uniformity of the final coating of lubricant is acceptable. Because the tray is exposed to air while the blades are being dipped, the liquid is constantly evaporating, causing a thicker solution. Constant adding of liquid is required to maintain the appropriate viscosity. In addition, the speed and technique that is used when dipping the blade in the solution causes high variation in the coating of the lubricant. It can become very operator dependant and can vary greatly from blade to blade.

The syringe application method was developed to prevent some of the drawbacks of the dipping technique. In this method, a vat of solution, similar to the dipping solution, is placed in an air tight container that is hooked up to a vacuum syringe system. When pressure is applied be the hardware, a very repeatable amount of solution is dispensed from the tip of the syringe head. A multi-axis robot is used to move the tip of the syringe along the blade edge, while applying pressure to the solution, to ensure a repeatable amount of solution is applied to the blade edge. Because the solution is contained in an air tight vat, the viscosity of the solution is maintained with little operator intervention. Also, with the robot moving at the same speed and in the same positions for every blade, the lubricant coating uniformity is much higher when compared to the dipping method. The disadvantage of this method is the high cost of the robotic system. The robot, vacuum syringe system, and up-keep of the equipment requires processing of thousands of blades to be cost effective and to justify the capital overhead of this method.

In view of the foregoing, presented herein are various methods and structures for applying a powdered lubricant to cleaning blade edges that can be used by small remanufacturing operations or field service engineers in a cost effective and reliable method. Using a marking pen similar to a felt-tipped marker (e.g., dry erase marker) the powdered lubricant and evaporating liquid can be swiped across the blade edge to enable a repeatable and reliable layer of powdered blade lubricant on the edge. The tip of the blade lubricating pen can be shaped to ensure that both surfaces of the blade working edge are sufficiently coated to prevent blade damage or blade flip when the drum is rotated against the blade. The sealed nature of the pen ensures that the solution does not “dry-out” and, if properly capped when not being used, can enable many uses without requiring intervention to adjust the viscosity of the solution.

More specifically, one powered lubricant fluid-delivery applicator structure embodiment herein comprises a casing having a closed end, and an open end opposite the closed end. A fluid-conducting applicator is located within the open end. The fluid-conducting applicator has an internal applicator section located within the casing, and an external applicator section extending outside the open end. A fluid is within the casing, and the fluid comprises a liquid and a powdered lubricant suspended in the liquid. The external applicator section comprises a tip having a V-shaped recess corresponding to the edge of the blade to which the powdered lubricant is applied.

The fluid-conducting applicator has internal spaces and passages that have sizes large enough to allow the powdered lubricant to pass when the liquid passes and these spaces and passages are sized such that the fluid is drawn from the internal applicator section to the external applicator section through the fluid-conducting applicator by way of capillary forces.

The casing has a cylindrical shape, and the cylindrical shape is sealed at the closed end. Conversely, the cylindrical shape has an opening at the open end, and the opening has a size corresponding to the size of the fluid-conducting applicator, such that the fluid-conducting applicator is held in place by the opening.

The liquid comprises a volatile liquid such as ammonia, acetone, methoxy-nonafluorobutane, isopropyl alcohol, diethyl ether, hydrogen cyanide, toluene, etc. The powdered lubricant comprises, for example, graphite, molybdenum disulfide, boron nitride, polytetrafluoroethylene (PTFE), zinc stearate, magnesium stearate or polymethylmethacrylate (PMMA), etc., and polymers thereof.

These and other features are described in, or are apparent from, the following detailed description.

### BRIEF DESCRIPTION OF THE DRAWINGS

Various exemplary embodiments of the systems and methods are described in detail below, with reference to the attached drawing figures, in which:

FIG. 1 is a perspective view schematic diagram of a device according to embodiments herein;

FIG. 2 is a side-view schematic diagram of a fluid-conducting applicator according to embodiments herein;

FIG. 3 is a perspective view schematic diagram of a device according to embodiments herein;

FIG. 4 is a side-view schematic diagram of a fluid-conducting applicator according to embodiments herein; and

FIG. 5 is a side-view schematic diagram of a fluid-conducting applicator according to embodiments herein.

### DETAILED DESCRIPTION

As mentioned above, the printing industry applies powdered lubricants to the edge of cleaning blades to reduce photoreceptor torque and prevent blade damage (tears/blade flip). This powder is typically applied to the blade edge using a liquid solution of powdered material suspended in a liquid that readily evaporates into the atmosphere.

Some processes for applying the liquid include dipping the blade edge in the solution, or using a robotically controlled syringe to ensure accurate application to the edge, as mentioned above. However, dipping requires close control of the viscosity of the solution since the liquid evaporates quickly when exposed to open air. The syringe method prevents the fast evaporation but requires high overhead costs. Small remanufacturing operations or field service technicians need a simple, easily portable, reliable, and cost effective device and method for applying the powdered lubricant to the cleaning blade edges, to ensure customer satisfaction of blade cleaning architectures.

While either of the conventional methods can be useful for manufacturing operations that process large volumes of blades, neither is very cost effective or efficient for the aftermarket remanufacturers or service engineers in the field. The aftermarket cartridge business is a multi-billion dollar industry that focuses on reusing end of life OEM (original equipment manufacturer) cartridges by cleaning the cartridges, replacing damaged components, and refilling the cartridges with toner for a second (or third, fourth, etc.) life, at a much lower cost than a new OEM cartridges. There are companies that supply this industry with replacement components, tools, processes, etc., allowing many independent suppliers to remanufacture an OEM cartridge and sell it on the open market to end users. However, such industries have a need for a simple and cost effective solution to applying blade lubrication. Typical aftermarket remanufacturing customers do not have the volume or overhead that can support a robotic application technique or the manufacturing control required for dipping.

A typical felt-tipped marker (e.g., dry-erase marker) contains pigment particles that are suspended in a water soluble liquid. This liquid is designed to evaporate when exposed to open air. A fibrous tip is immersed in the solution and provides a medium for the solution to be brought to the working tip of the pen through capillary force within the fibers. When placed against an appropriate surface, the solution of liquid and pigment are applied to the surface. Once exposed to open air, the liquid medium evaporates into the atmosphere, leaving behind the colored pigment. The pigment is easily removed with a cloth or erasing material.

By replacing the pigment with a powdered lubricant, a marker/pen device is used to apply a uniform coating of lubricant to the edges of cleaning blade edges. The powdered lubricant materials come in all shapes and sizes and are readily available on the market (e.g., graphite, molybdenum disulfide, boron nitride, polytetrafluoroethylene (PTFE), zinc stearate, magnesium stearate or polymethylmethacrylate (PMMA), etc., and polymers of such substances, etc.). There are also many different solvents available (e.g., ammonia, acetone, methoxy-nonafluorobutane, isopropyl alcohol, diethyl ether, hydrogen cyanide, toluene, etc.) that can be matched with the appropriate lubricant to enable optimal dispensing through the fiber tips of a disposable marker. One embodiment uses 300 nanometer polymethylmethacrylate particles that have been dispersed in methoxy-nonafluorobutane. While some common lubricants and volatile liquids are mentioned above, the embodiments herein are not limited to these specific materials and, as would be understood by those ordinarily skilled in the art, any lubricant and any volatile material (whether currently known or developed in the future) could be used with embodiments herein.

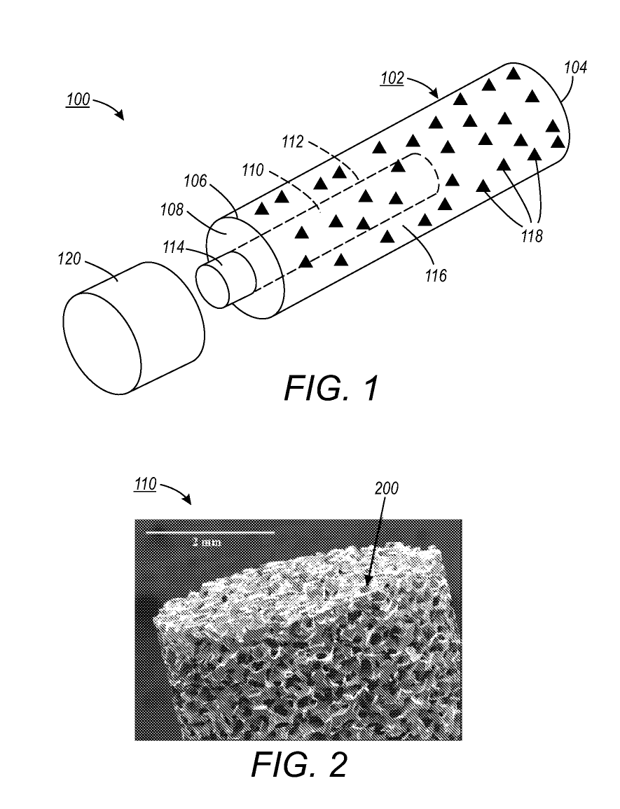

More specifically, one powered lubricant fluid-delivery applicator embodiment 100 is shown in perspective view in FIG. 1. As shown, this apparatus comprises a casing 102 having a closed end 104, and an open end 106 opposite the closed end 104. FIG. 1 illustrates that the casing 102 has a cylindrical shape, and the cylindrical shape is sealed at the closed end 104. Conversely, the cylindrical shape has an opening 108 at the open end 106.

A fluid-conducting applicator 110 is located within the open end 106. The fluid-conducting applicator 110 has an internal applicator section 112 located within the casing 102, and an external applicator section 114 extending outside the open end 106. The opening 108 has a size corresponding to the size of the fluid-conducting applicator 110, such that the fluid-conducting applicator 110 is held in place by the opening 108.

A fluid 116, 118 is within the casing 102, and the fluid 116, 118 comprises a liquid 116 and a powdered lubricant 118 suspended in the liquid 116. The liquid 116 comprises a volatile liquid such as ammonia, acetone, methoxy-nonafluorobutane, isopropyl alcohol, diethyl ether, hydrogen cyanide, toluene, etc. The powdered lubricant 118 comprises, for example, graphite, molybdenum disulfide, boron nitride, polytetrafluoroethylene (PTFE), zinc stearate, magnesium stearate, or polymethylmethacrylate (PMMA), etc., and polymers thereof.

A removable cap 120 that fits on the cylindrical casing 102 is also illustrated in FIG. 1. The cap 120 prevents the liquid 116 from evaporating from the external applicator section 114 when the fluid-delivery applicator 100 is not in use.

As shown in cross-section in FIG. 2, the fluid-conducting applicator 110 has internal spaces and passages 200 that have sizes large enough to allow the powdered lubricant 118 to pass when the liquid 116 passes, and these spaces and passages 200 are sized such that the fluid 116, 118 is drawn from the internal applicator section 112 to the external applicator section 114 through the fluid-conducting applicator 110 by way of capillary forces.

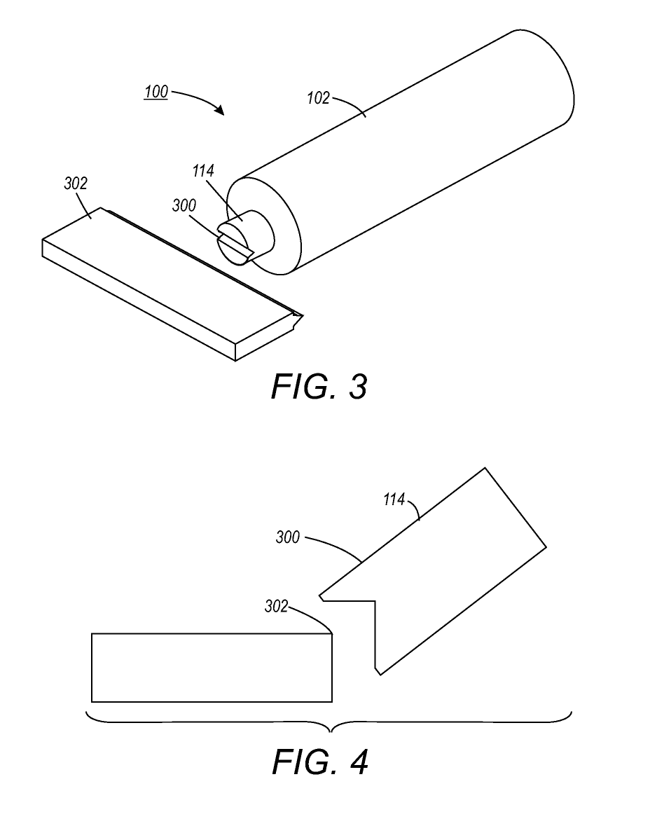

As shown in perspective view FIG. 3, the tip 300 of the marker can be sized and shaped to match the edge of a blade 120 to ensure both the blade surface and the blade edge receive the coating. Thus, as shown in FIG. 3, the external applicator section 114 comprises a tip 300 having a V-shaped recess 300 corresponding to a blade working edge 302 to which the powdered lubricant 118 is applied. The V-shape of the tip 300 of the external applicator section 114 is also shown in cross-sectional view in FIG. 4. In addition, FIG. 4 also illustrates how the blade 302 has a shape that corresponds to the recess 300 within that the external applicator section 114.

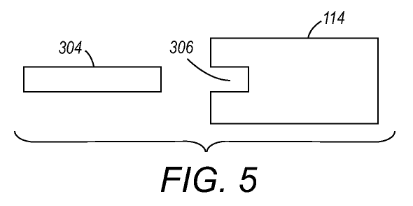

Therefore, as shown by FIG. 4 with embodiments herein, the tip 300 of the external applicator section 114 can be customized for each structure to which it will apply the lubricant. Another example is shown in cross-section in FIG. 5. Here, the tip 306 is customized to have a shape corresponding to a rectangular blade 304. As with the previous embodiments, the tip of the external applicator section 114 is customized so that it easily fits over the edge of the item that is to receive the powdered lubricant.

By forming the tips of the external applicator section 114 to have shapes that correspond to the items that will receive the powdered lubricant, the embodiments herein provide a uniform application of the powdered lubricant, and thereby increase performance and decrease the amount of damage that will be seen within those items.

As would be understood by those ordinarily skilled in the art, the structures shown in the foregoing figures are only examples and the embodiments herein are not limited to the shapes, sizes, materials, etc., that are discussed herein. Therefore, while the casing 102 is illustrated as being a cylinder, it can have tapered ends, a rectangular shape, an oval shape, a contoured shape, clips, recesses, etc., to allow greater ease of use. Further, the casing 102 can have different shapes (lips, ridges, etc.) that help maintain the cap 120 in the correct position.

Similarly, the while the applicator 110 is illustrated as a cylinder, it can have a rectangular shape, oval shape, or any other shape which helps improve the capillary action within the applicator 110. Further, as would be understood by those ordinarily skilled in the art, the opening 108 within the open end 106 of the casing 102 can change to correspond to the shape of the applicator 110. So long as the opening 108 maintains the applicator 110, the embodiments herein will have proper and superior functioning capabilities.

Also, while one pattern of spaces and passages 200 within the applicator 110 is illustrated in FIG. 2, those ordinarily skilled in the art would understand that many different patterns of spaces and passages 200 could be utilized to promote proper capillary action.

Further, while a few exemplary tip shapes are shown in the drawings above, those ordinarily skilled in the art would understand that any tip shape could be utilized with the embodiments herein and that the tip shape is primarily dependent upon the item that will receive the powdered lubricant. Therefore, as would be understood by those ordinarily skilled in the art, the embodiments herein can have any tip shape and are not limited by the examples are presented in the drawings and that are discussed above.

Therefore, the embodiments herein are not limited to the specific structures illustrated in the drawings, but are applicable to any structures that would accomplish the function of delivering a fluid containing lubricating particles through the use of a marker or pen apparatus.

This applicator for blade lubricant provides a cost effective, easily manufactured, and highly portable device that permits the consistently repeatable method for field service engineers or manufacturers of remanufactured cartridges to apply powdered lubricants.

The terms printer or printing device as used herein encompasses any apparatus, such as a digital copier, bookmaking machine, facsimile machine, multi-function machine, etc., which performs a print outputting function for any purpose. The details of printers, printing engines, etc., are well-known by those ordinarily skilled in the art and are discussed in, for example, U.S. Pat. No. 6,032,004, the complete disclosure of which is fully incorporated herein by reference. The embodiments herein can encompass embodiments that print in color, monochrome, or handle color or monochrome image data. All foregoing embodiments are specifically applicable to electrostatographic and/or xerographic machines and/or processes.

It will be appreciated that the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims. The claims can encompass embodiments in hardware, software, and/or a combination thereof. Unless specifically defined in a specific claim itself, steps or components of the embodiments herein cannot be implied or imported from any above example as limitations to any particular order, number, position, size, shape, angle, color, or material.

What is claimed is:

1. A fluid-delivery applicator structure comprising:
a casing having a closed end, and an open end;
a fluid-conducting applicator located within said open end, said fluid-conducting applicator comprising an internal applicator section located within said casing, and an external applicator section extending outside said open end; and
a fluid within said casing, said fluid comprising a liquid and a powder suspended in said liquid,
said external applicator section comprising a tip.

2. The fluid-delivery applicator structure in claim 1, said fluid-conducting applicator comprising internal spaces and passages having sizes large enough to allow said powder to pass through said fluid-conducting applicator when said liquid passes through said fluid-conducting applicator.

3. The fluid-delivery applicator structure in claim 1, said fluid being drawn through said fluid-conducting applicator by way of capillary forces.

4. The fluid-delivery applicator structure in claim 1, said casing having a cylindrical shape, said cylindrical shape being sealed at said closed end, and said cylindrical shape having an opening at said open end, said opening having a size corresponding to a size of said fluid-conducting applicator.

5. The fluid-delivery applicator structure in claim 4, said fluid-conducting applicator being held in place by said opening.

6. The fluid-delivery applicator structure in claim 1, said powder comprising a lubricant and said liquid comprising a volatile liquid.

7. The fluid-delivery applicator structure in claim 1, said powder comprising one of: graphite, molybdenum disulfide, boron nitride, polytetrafluoroethylene (PTFE), zinc stearate, magnesium stearate, polymethylmethacrylate (PMMA) and polymers thereof.

8. A fluid-delivery applicator structure comprising:
a casing having a closed end, and an open end;
a fluid-conducting applicator located within said open end, said fluid-conducting applicator comprising an internal applicator section located within said casing, and an external applicator section extending outside said open end; and
a fluid within said casing, said fluid comprising a liquid and a powder suspended in said liquid,
said external applicator section comprising a tip having a recess corresponding to a blade to which said powder is applied.

9. The fluid-delivery applicator structure in claim 8, said fluid-conducting applicator comprising internal spaces and passages having sizes large enough to allow said powder to pass through said fluid-conducting applicator when said liquid passes through said fluid-conducting applicator.

10. The fluid-delivery applicator structure in claim 8, said fluid being drawn through said fluid-conducting applicator by way of capillary forces.

11. The fluid-delivery applicator structure in claim 8, said casing having a cylindrical shape, said cylindrical shape being sealed at said closed end, and said cylindrical shape having an opening at said open end, said opening having a size corresponding to a size of said fluid-conducting applicator.

12. The fluid-delivery applicator structure in claim 4, said fluid-conducting applicator being held in place by said opening.

13. The fluid-delivery applicator structure in claim 8, said powder comprising a lubricant and said liquid comprising a volatile liquid.

14. The fluid-delivery applicator structure in claim 8, said powder comprising one of:
graphite, molybdenum disulfide, boron nitride, polytetrafluoroethylene (PTFE), zinc stearate, magnesium stearate, polymethylmethacrylate (PMMA) and polymers thereof.

15. A powered lubricant fluid-delivery applicator structure comprising:
a casing having a closed end, and an open end opposite said closed end;
a fluid-conducting applicator located within said open end, said fluid-conducting applicator comprising an internal applicator section located within said casing, and an external applicator section extending outside said open end; and
a fluid within said casing, said fluid comprising a liquid and a powdered lubricant suspended in said liquid,
said external applicator section comprising a tip having a V-shaped recess corresponding to a blade to which said powdered lubricant is applied.

16. The fluid-delivery applicator structure in claim 15, said fluid-conducting applicator comprising internal spaces and passages having sizes large enough to allow said powdered lubricant to pass through said fluid-conducting applicator when said liquid passes through said fluid-conducting applicator.

17. The fluid-delivery applicator structure in claim 15, said fluid being drawn through said fluid-conducting applicator by way of capillary forces.

18. The fluid-delivery applicator structure in claim 15, said casing having a cylindrical shape, said cylindrical shape being sealed at said closed end, and said cylindrical shape having an opening at said open end, said opening having a size corresponding to a size of said fluid-conducting applicator.

19. The fluid-delivery applicator structure in claim 15, said liquid comprising a volatile liquid.

20. The fluid-delivery applicator structure in claim 15, said powdered lubricant comprising one of: graphite, molybdenum disulfide, boron nitride, polytetrafluoroethylene (PTFE), zinc stearate, magnesium stearate, polymethylmethacrylate (PMMA) and polymers thereof.
